(19) United States
(12) Patent Application Publication
(10) Pub. No.: US 2025/0289042 A1
(43) Pub. Date: Sep. 18, 2025

(54) METHOD AND DEVICE FOR PROCESSING SOLAR MODULES

(71) Applicant: SOLAR MATERIALS GMBH, Magdeburg (DE)

(72) Inventors: Jan BARGEL, Magdeburg (DE); Fridolin FRANKE, Magdeburg (DE); Jan-Philipp MAI, Magdeburg (DE)

(21) Appl. No.: 18/860,933

(22) PCT Filed: May 5, 2023
(86) PCT No.: PCT/EP2023/062042

§ 371 Date: Oct. 28, 2024

(30) Foreign Application Priority Data
May 17, 2022 (DE) 10 2022 112 294.8
Jul. 6, 2022 (DE) 10 2022 116 810.7

(51) Int. Cl. B09B 3/50; B09B 3/30; B09B 101/15; H02S 50/00

(52) U.S. Cl. CPC B09B 3/50; B09B 3/30; H02S 50/00; B09B 2101/15

(57) ABSTRACT

The invention relates to a method for processing solar modules by means of a recycling installation, the method comprising the following steps: detecting the solar module by means of at least one sensor, so that the at least one sensor sends measurement data to an electrical control unit, the measurement data containing information on the solar module; evaluating the measurement data and determining operating parameters for the recycling installation; and processing the solar module in the recycling installation that is operated with the determined operating parameters.

The invention relates to a method for processing solar modules by means of a recycling installation as well as a device for conducting such a method.

Different designs of solar module are being used in increasing numbers to generate electricity from sunlight. For example, said solar modules may be placed in small numbers on roofs of private buildings, such as residential buildings, in order to at least partially meet the electricity demand of the house on which the solar modules are mounted. This use of this kind of decentralized energy supply is increasing, for example to charge electric vehicles decentrally. However, solar modules are also used in large installations on otherwise agricultural land to generate commercial electricity and feed it into the public grid.

The problem is that solar modules only have a limited service life. Expensive raw materials are used during production of solar modules. For example, most solar modules have electric conductor tracks made of silver. For this reason alone, there is a need for a method that recycles said raw materials and makes them available for reprocessing. In addition, the growing number of solar modules that reach the end of their service life and are therefore discarded creates a large amount of waste, which should be recycled or treated, particularly in view of the environmental compatibility of electricity generation, of which solar modules and the generation of electricity from sunlight are emblematic.

A wide range of solar modules is known from the prior art. However, some elements are contained in most known solar modules. Solar modules generally have a base body on which electric conductor tracks or other metal components are arranged. Said base body can be made of silicon or glass. In addition, solar modules usually have a cover layer that limits the solar module to the outside and is at least partially, but preferably completely, made of glass or another material that is transparent to visible light.

Different solar modules have to be recycled in different ways in order to get to the valuable raw materials and to render them accessible for further utilization. As a result, various methods are known from a range of documents from the prior art. For solar modules which contain metal components arranged on a glass substrate, JP 2014/054593 A, for example, proposes a method in which the components are mechanically removed.

The invention aims to simplify the method for processing solar modules and to be able to process a greater number of differently designed solar modules.

The invention also solves the addressed task by way of a method for processing solar modules by means of a recycling installation, the method comprising the following steps:
detecting the solar module by means of at least one sensor, so that the at least one sensor sends measurement data to an electrical control unit, the measurement data containing information on the solar module,
evaluating the measurement data and determining operating parameters for the recycling installation, and
processing the solar module in the recycling installation that is operated with the determined operating parameters.

In the method according to the invention, the solar module to be processed is consequently detected by means of a sensor. The solar module can be detected either fully or partially—it is only important that the measurement data obtained contains information on the solar module. The measurement data that is sent by the sensor to the electrical control unit contains information on the solar module. This information contains, for example, geometric dimensions and/or the weight of the solar module or of one or multiple parts of the solar module, for example individual layers. The information may also contain information on transmission properties and/or materials or raw materials from which the solar module is at least partially made. Additionally or alternatively, the information may contain a type designation, a manufacturer name, a logo, a serial number and/or a series, a barcode or a QR code, so that the type of solar module can be identified to the extent that the operating parameters can be determined. To this end, it is an advantage if the solar module can be clearly identified. However, in many cases it is sufficient to determine just some parameters or properties of the solar module or, for example, a series or classification of the solar module.

Measurement data refers particularly to all data that can be detected and transmitted by a sensor, in particular including image data and the information contained therein.

The electrical control unit is preferably an electronic data processing device which is able to evaluate the measurement data transmitted to it by the sensor and to determine operating parameters on the basis of the evaluated measurement data and/or the information on the solar module extracted from said data, said parameters being used during subsequent processing of the solar module to operate the recycling installation.

The at least one sensor preferably has at least one optical sensor, in particular at least one optical camera and/or one barcode scanner, wherein the measurement data is preferably digital image data. Alternatively or additionally, the at least one sensor has an acoustic sensor that comprises, for example, an ultrasonic sensor and preferably an ultrasonic transmitter. Alternatively or additionally, the at least one sensor has at least one distance sensor, at least one balance, at least one layer thickness sensor and/or a system for performing Laser Induced Breakdown Spectroscopy (LIBS).

Particularly preferably, the measurement data is evaluated by image recognition software. The image recognition software is run in the electrical control unit and evaluates the measurement data that is transmitted by the at least one optical sensor. Advantageously, the measurement data is compared by the electrical control unit with reference data stored in an electronic database.

Particularly preferably, the electrical control unit is able to clearly determine the type of solar module from the measurement data. This is the case, for example, if the image recognition software recognizes a type designation and/or a serial number in the measurement data, i.e. in the digital image data. The type designation and/or serial number does not necessarily have to be in the form of letters and/or numbers, but can also be provided and detected in a purely machine-readable form, for example in the form of a barcode or a QR code. The electrical control unit is preferably configured to access an electronic memory that contains information on the various types of solar module in an electronic format that can be read by the electrical control unit. The electronic memory preferably contains a database in which the respective operating parameters for the various types of solar modules that can be processed are stored. The electrical control unit is preferably configured to compare a detected solar module type with the entries in the database and thus select the optimal operating parameters stored in the database for this type of solar module.

The electrical control unit sends control commands to the recycling installation that contain the operating parameters in a format that can be understood by the recycling installation, so that the recycling installation is operated for the solar module to be processed using the operating parameters determined.

In addition to the type of solar module, the measurement data may also contain information about individual components and layers of the solar module. For example, this relates to the geometric dimensions, i.e. spatial expansion, of the different layers. The measurement data can contain, for example, information about the size and/or thickness of a glass layer, such as a cover layer, and/or information on the refractive index and/or the reflection coefficients of the glass used and/or information on the composition of the glass; this information can then be evaluated by the electrical control unit. In this case, the electrical control unit is preferably configured to access an electronic database in an electronic memory in order to determine the necessary operating parameters from the evaluated measurement data and the information extracted from it.

The solar module preferably has a base body with an upper side on which the metallic conductor tracks are arranged. In addition, the solar module also has a cover layer, which is arranged on the upper side of the base body by means of an adhesive layer. When processing the solar module, the adhesive layer heats up, meaning that it at least partially, but preferably completely, loses its adhesive effect. The cover layer is subsequently removed from the base body using a tool. The conductor tracks are then mechanically machined, wherein the machined material is collected.

The operating parameters preferably indicate how long, in which way, how quickly and/or at which temperature the adhesive layer is heated and/or whether the entire adhesive layer or which part of the adhesive layer is heated. Preferably, the adhesive layer is heated by means of infrared radiation and/or magnetic induction and/or by means of microwave radiation. The recycling installation preferably has a separate heat source for several of these options, but preferably for all of them. In this case, the operating parameters indicate which of these heat sources is used. Preferably, the recycling installation has a plurality of heat sources. They may enable different heating options or the same heating option. For example, multiple heat sources of one type can be provided, such as multiple infrared radiation sources. The operating parameters preferably indicate which heat sources are used to heat the adhesive layer or the part of the adhesive layer. This is useful, for example, if the heat sources are configured to heat a spatial area that is larger than the upper side of the solar module.

Heating is preferably conducted at a temperature of more than 180° C., preferably more than 200° C., especially preferably more than 230° C., and less than 400° C., preferably less than 350° C., especially preferably less than 280° C. The operating parameters preferably indicate which temperature is used.

In particular, it is advantageous when using infrared radiation or microwave radiation to apply the radiation through the cover layer, which is at least partially transparent, but preferably completely transparent, to the respective type of radiation. Infrared radiation used for this purpose preferably has a wavelength between 1000 and 4000 nm, preferably from 1000 to 2000 nm. The operating parameters preferably indicate which wavelength is used. If microwave radiation is used, it preferably has a frequency of between 2.4 GHz and 2.5 Ghz, preferably 2.45 GHz. Alternatively, the microwave radiation has a frequency of 5.8 GHz.

During heating by means of magnetic induction, alternating magnetic fields are used which preferably have a frequency of between 1 kHz and 500 kHz. A suitable frequency range is referred to as a low frequency range and encompasses frequencies between 1 kHz and 7 kHz. A different frequency range is referred to as a medium frequency range and contains frequencies between 8 kHz and 40 kHz. The high frequency range contains frequencies between 60 kHz and 500 kHz. The frequency used is preferably between 25 kHz and 300 kHz, especially preferably between 25 kHz and 100 kHz.

The operating parameters preferably indicate which tool is used to remove the cover layer, preferably whether a spatula, scraper, knife, blade and/or wire and/or another tool is used. Particularly preferably, the operating parameters indicate which working parameters should be used. For example, the working parameters contain information on an angle of attack and/or a contact pressure of the tool.

In a preferred embodiment, the operating parameters indicate the removal procedure used to remove the conductor tracks. In particular, the operating parameters indicate whether this is done by brushing, milling, planing, shaping, scraping, chiselling, broaching, blasting and/or grinding. Particularly preferably, the operating parameters contain the process parameters of the removal procedure. The process parameters contain, for example, information on the angle of attack and/or a contact pressure of the tool, a rotation speed of brushes and/or grinding elements or the forces used or stroke frequencies.

The operating parameters preferably indicate whether the cover layer is damaged prior to removal. If this is the case, the operating parameters preferably also indicate whether the cover layer is damaged by means of a spatula, scraper, knife and/or wire and/or another tool.

During the method, the adhesive layer is preferably heated to an adhesive layer temperature and the lower side of the base body cooled to a lower side temperature. Heating the adhesive layer makes it possible to remove the cover layer from the rest of the layer element. The cover layer is preferably a glass layer which, particularly preferably, is designed to be completely transparent for visible light. By heating the adhesive layer, the adhesive force of the adhesive layer decreases and the cover layer can be removed. The heat introduced into the adhesive layer spreads inside the layer element and gradually heats other layers and elements of the layer element. A plastic layer, for example of polyvinyl fluoride (PVF), is often arranged on the lower side of the base body. The material of this plastic layer is usually less heat-resistant than the base body, the cover layer and especially the adhesive layer. The heat introduced to heat the adhesive layer also heats the plastic layer and can cause it to disintegrate, which can release gases that are harmful and pose a health hazard. According to the invention, this is prevented by cooling the lower side of the base body to a lower side temperature.

Within the context of the present invention, processing a layer element comprises, for example, at least partially dismantling the layer element. In one preferred embodiment, this is achieved by either completely or partially removing the cover layer from the base body. This is preferably done without damaging or destroying the cover layer in the process. However, this is not necessarily the case. Even if the cover layer is damaged or destroyed during complete or partial removal from the base body and/or prior to complete or partial removal from the base body, it still constitutes “processing” within the context of the present invention.

This does not mean that the lower side is cooled during the method to a temperature below room temperature, for example. Prior to starting the method, the lower side of the base body of the layer element is at a temperature that is significantly lower than the lower side temperature that is aimed for during the method. All it means is that heat is dissipated from the lower side of the base body in order to achieve and preferably maintain the lower side temperature. The lower side temperature is lower than the adhesive layer temperature.

In order to cool the lower side of the base body to a lower side temperature, a cooling device is provided to dissipate heat from the lower side of the base body.

One difficulty that is eliminated by the method in these embodiments is that the conductor tracks of the layer elements, for example of solar modules, which are produced from the valuable raw material, are not accessible from the outside. They are located on the upper side of the base body, but are covered by the cover layer, which is fixed by the at least one adhesive layer. Heating the adhesive layer reduces its adhesive effect so that the cover layer and base body can be removed from each other afterwards. The conductor tracks arranged on the upper side of the base body are then accessible. They are now removed from the base body by mechanical removal and the removed material is collected.

The operating parameters preferably indicate how long, in which way, how quickly and/or at which temperature the lower side is cooled and/or whether the entire lower side or which part of the lower side is cooled.

The layer element preferably refers to a solar module, wherein the layer element preferably comprises conductor tracks which, particularly preferably, are arranged on the upper side of the base body and are covered by the cover layer.

Preferably, the adhesive layer temperature is at least 180° C., preferably at least 200° C., especially preferably at least 230° C., and at most 400° C., preferably at most 350° C., especially preferably at most 280° C. This is particularly advantageous if the adhesive layer is a layer made of or with ethylene-vinyl acetate (EVA). The adhesive layer temperature is preferably selected in such a way that pyrolysis of the adhesive layer does not occur, which can release partially poisonous and environmentally harmful gases. This is prevented by a temperature below 400° C. At a temperature of more than 180° C., preferably more than 200° C., acetic acid in an EVA adhesive layer is released, which creates a lubricating film between the layers connected by the adhesive layer. This causes forces of adhesion, which are applied by the adhesive layer, to decrease and the two connected elements can be separated from each other. Preferably, therefore, at least one EVA film is also used as an adhesive layer.

The lower side temperature is preferably at most 150° C., preferably at most 110° C., especially preferably at most 100° C. The lower this temperature, the smaller the effects of the heat on layers arranged on the lower side of the base body.

The base body preferably has a structure composed of multiple layers arranged next to each other. The lower side of the base body constitutes the lower side of the cover element that is processed using the method described here. For example, the base body has a substrate, which is preferably produced from silicon, particularly preferably made of silicon, and a charge-doped zone and a hole-doped zone. The metallic conductor tracks are arranged on the upper side of this substrate, which forms the upper side of the base body. The lower side of the substrate does not necessarily have to form the lower side of the layer element. Further layers, such as the previously mentioned plastic layer, can be arranged on the lower side of the substrate. The lower side of the base body preferably forms the lower side of the layer element.

The invention also solves the addressed task by way of a device for processing solar modules, wherein the device has at least one sensor for detecting the solar module, a recycling installation and an electrical control unit, which is configured to carry out a method described here.

The device preferably has a heating device for heating the adhesive layer of a layer element to the adhesive layer temperature and a cooling device for cooling the lower side of the base body of the layer element to the lower side temperature.

Preferably, the device has a holding device with which the layer element processed using the device is held. The device preferably has a workbench for supporting the layer element, the cooling device preferably being arranged within the workbench. In a particularly preferred embodiment, the workbench has a contact surface on which the layer element rests while the method is conducted. This contact surface can preferably be cooled by the cooling device. The holding device with which the layer element is held is, for example, a traction device for exerting a tensile force. It may comprise, for example, a negative pressure element, such as a suction element. The layer element is positioned, for example, on openings within the contact surface, which are sealed by the layer element. By applying a negative pressure or a suction force to the sealed openings, a suction force and therefore a tensile force is exerted on the layer element that holds it on the contact surface.

Alternatively or additionally, the holding device has a pressure device for exerting a compressive force. This compressive force causes the layer element to be pressed onto the contact surface. The pressure device preferably comprises at least one, preferably multiple, hold-down clamps. They can preferably be moved relative to the contact surface. The hold-down clamps are preferably removed from the contact surface in order to arrange a layer element to be processed on the contact surface. The hold-down clamps are then lowered until they come into contact with the layer element and are able to apply a compressive force to the layer element.

Preferably, the cooling device has at least one fluid channel, through which a coolant can be directed. The coolant is, for example, a cooling liquid such as water. The cooling device preferably has a pump, by means of which the coolant can be moved through the fluid channel. If the fluid channel is situated within the workbench, it is advantageous for said workbench to be made of a material with high thermal conductivity, for example a metal, such as aluminium or steel.

The at least one cooling channel is preferably located as close to the actual contact surface of the workbench as possible, for example at most 15 cm, preferably at most 10 cm, especially preferably at most 5 cm, away from the contact surface. The material of the workbench, at least the material of the workbench between the at least one cooling channel and the contact surface, preferably has a high thermal conductivity. The material is preferably a metal, such as aluminium or steel.

Alternatively or additionally, the cooling device has at least one fan through which the air can be directed onto the lower side of the layer element. The fan may be designed, for example, in the form of one or multiple ventilators, which are arranged and aligned such that they move air towards the lower side of the layer element.

The device preferably has a first temperature sensor for detecting the adhesive layer temperature and/or a second temperature sensor for detecting the lower side temperature. Preferably, the first temperature sensor and/or the second temperature sensor have/has a pyrometer by means of which the temperatures that occur can be detected, preferably in a contactless manner.

The device preferably has an electronic control unit, especially preferably an electronic data processing device, which is configured to control the heating device and/or the cooling device depending on the detected adhesive layer temperature and/or the detected lower side temperature. To this end, the respective detected temperature is compared with a target temperature stored in an electronic memory. The target temperature may also be a temperature range, within which the detected temperature should lie. The electrical control unit is configured in such a way that it increases the power of the heating device and/or increases the duration of heating if the detected adhesive layer temperature is considered too low after comparison with a stored target temperature. Alternatively or additionally, the electrical control unit is preferably configured in such a way that it increases the power of the cooling device and/or increases the duration of cooling if the detected lower side temperature is considered too high after comparison with a stored target temperature.

1. A method for processing solar modules by a recycling installation, comprising the:
detecting at least one solar module by at least one sensor; sending to an electrical control unit measurement data containing information on the solar module;
evaluating, using the electrical control unit, the measurement data and determining, using the electrical control unit, operating parameters for the recycling installation; and
processing the at least one solar module in the recycling installation according to operating parameters determined by the electrical control unit.

2. The method according to claim 1 wherein the at least one sensor comprises at least one optical sensor.

3. The method according to claim 1 wherein the measurement data is evaluated by an image recognition software that compares the measurement data with reference data stored in an electronic database.

4. The method according to claim 1 wherein the solar module comprises a base body with an upper side on which metallic conductor tracks are arranged, and a cover layer arranged on the upper side of the base body by an adhesive layer, wherein the adhesive layer heats up during processing of the solar module, wherein the cover layer is removed from the base body by a tool after heating up, wherein the metallic conductor tracks are mechanically removed after removal of the cover layer, and wherein the cover layer and the metallic conductor tracks are is collected.

5. The method according to claim 4, wherein the operating parameters indicate one or more of
how long,
in which way,
how quickly, and
at which temperature
the adhesive layer is heated, and/or
whether the entire adhesive layer or which part of the adhesive layer is heated.

6. The method according to claim 4 wherein the operating parameters indicate the tool that is used to remove the cover layer.

7. The method according to claim 6, wherein the operating parameters contain working parameters of the tool.

8. The method according to claim 4 wherein the operating parameters indicate a removal procedure to be used to remove the metallic conductor tracks.

9. The method according to claim 8, wherein the operating parameters contain process parameters of the removal procedure.

10. The method according to claim 4 wherein the operating parameters indicate whether the cover layer is damaged prior to removal.

11. A device for processing solar modules, comprises:
at least one sensor for detecting the solar module;
a recycling installation and an electrical control unit configured to carry out a method according to claim 1.

12. The method of claim 2 wherein the at least one optical sensor is a digital camera.

13. The method of claim 1 wherein the measurement data comprises digital image data.

14. The method of claim 6 wherein the tool is selected from the group consisting of a spatula, a scraper, a knife, a blade, and a wire.

15. The method according to claim 8 wherein the removal procedure is selected from one or more of brushing, milling, planing, shaping, scraping, chiselling, broaching, blasting, and and/or grinding.

16. The method of claim 10 wherein the damage is caused by a spatula, a scraper, a knife, and/or a wire.
